(19) United States
(12) Patent Application Publication
(10) Pub. No.: US 2018/0128345 A1
(43) Pub. Date: May 10, 2018

(54) VIBRATION ABSORBER AND SEMI-ACTIVE VIBRATION REDUCTION METHOD USING THE SAME

(71) Applicant: INDUSTRIAL TECHNOLOGY RESEARCH INSTITUTE, Hsinchu (TW)

(72) Inventors: Chen-Yu Kai, Pingtung County (TW); Jen-Ji WANG, Taichung City (TW); Jung-Che Lee, Taichung City (TW); Yi-Hsuan Chen, Nantou County (TW); Chung-Yu Tai, Kaohsiung City (TW)

(21) Appl. No.: 15/384,933

(22) Filed: Dec. 20, 2016

(30) Foreign Application Priority Data
Nov. 7, 2016 (TW) 105136143

(51) Int. Cl. F16F 15/00; F16F 15/04; B23Q 11/00

(52) U.S. Cl. CPC F16F 15/002; F16F 2228/04; B23Q 11/0039; F16F 15/04

(57) ABSTRACT

A vibration absorber includes a screw, a displacement adjustment member, a first spring, a second spring, a mass block, a casing, a cover and a connector. The displacement adjustment member is engaged with the screw. The mass block is located between the first spring and the second spring, wherein the mass block respectively connects the first spring and the second spring on both sides and the screw passes through the mass block. The casing encloses the screw, the displacement adjustment member, the first spring, the second spring and the mass block. The cover covers one opening of the casing. The connector covers the other opening of the casing. The first spring is located between the mass block and the displacement adjustment member and connects respectively the mass block and the displacement adjustment member. The coefficients of elasticity of both the first spring and the second spring are both non-linear.

This application claims the benefit of Taiwan application Serial No. 105136143, filed Nov. 7, 2016, the subject matter of which is incorporated herein by reference.

### TECHNICAL FIELD

The disclosure relates in general to a vibration absorber and a vibration reduction method using the same, and more particularly to a vibration absorber and a semi-active vibration reduction method using the same.

### BACKGROUND

The cutting performance of a machine tool varies with the cut depth and the rotation speed. When the cutting condition falls within the unstable area of a chatter stability diagram, this implies that cutting is in an unstable state and will cause the machine tool to chatter. In a practical machining process, an experienced machine operator will normally avoid working under the unstable area of a chatter stability diagram. However, the operating range of the machine tool will be passively restricted.

Therefore, it has become a prominent task for the industries to provide a new technique for resolving the above problems.

### SUMMARY OF THE DISCLOSURE

According to one embodiment of the present disclosure, a vibration absorber is provided. The vibration absorber is installed on a rotation module. The vibration absorber includes a screw, a displacement adjustment member, a first spring, a second spring, a mass block, a casing, a cover and a connector. The displacement adjustment member is engaged with the screw. The mass block is located between the first spring and the second spring, wherein the mass block respectively connects the first spring and the second spring on both sides, and the screw passes through the mass block. The casing is configured to enclose the screw, the displacement adjustment member, the first spring, the second spring and the mass block. The cover is configured to cover one opening of the casing. The connector is configured to cover the other opening of the casing. The first spring is located between the mass block and the displacement adjustment member and connects respectively the mass block and the displacement adjustment member by both ends, the second spring is located between the mass block and the cover and connects respectively the mass block and the cover by both ends, and the coefficients of elasticity of both the first spring and the second spring both are both non-linear.

According to another embodiment of the present disclosure, a semi-active vibration reduction method is provided. The semi-active vibration reduction method includes following steps: sensing the processing state of a rotation module equipped with the said vibration absorber; determining whether the rotation module chatters is determined; determining an amount of displacement corresponding to an operating frequency according to a relationship of displacement and frequency if it is determined that the rotation module chatters; and displacing the displacement adjustment member by the amount of displacement.

The above and other aspects of the present disclosure will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of a machine tool equipped with a vibration absorber according to an embodiment of the present disclosure.

FIG. 2 is a diagram of frequency and response of the machine tool of FIG. 1.

FIG. 3 is a chatter stability diagram of the machine tool of FIG. 1.

FIG. 4 is a cross-sectional view of the vibration absorber of FIG. 1.

FIG. 5A is a diagram of a relationship of amount of displacement and applied force of the displacement adjustment member of FIG. 4.

FIG. 5B is a diagram of a relationship of operating frequency and response of the machine tool of FIG. 4.

FIG. 6 is an equivalent system of the machine tool of FIG. 1 equipped with a vibration absorber.

FIG. 7 is a flowchart of a vibration reduction method according to an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION OF THE DISCLOSURE

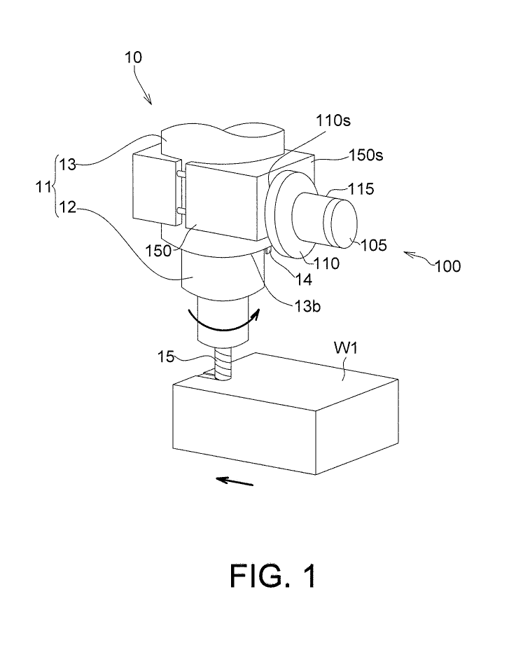

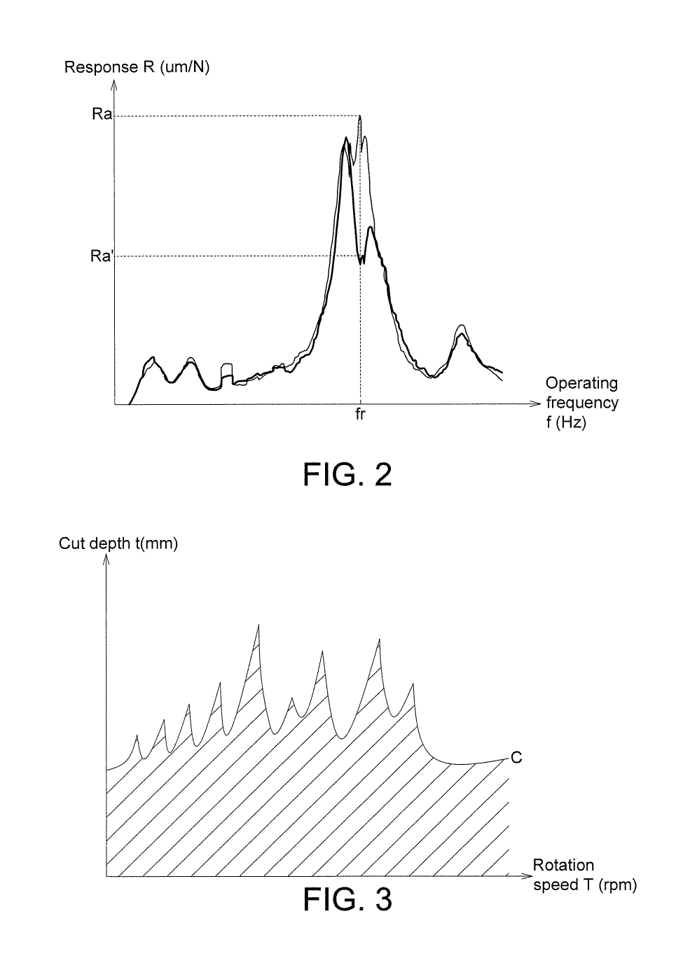

Refer to FIGS. 1-3. FIG. 1 is a schematic diagram of a machine tool 10 equipped with a vibration absorber 100 according to an embodiment of the present disclosure. FIG. 2 is a diagram of frequency and response of the machine tool 10 of FIG. 1. FIG. 3 is a chatter stability diagram of the machine tool 10 of FIG. 1.

As indicated in FIG. 1, the machine tool 10 at least includes a rotation module 11, and the vibration absorber 100 is exemplarily installed on the rotation module 11. The rotation module 11 includes a shaft 12 and a fixing base 13. The shaft 12 is connected to the fixing base 13 and can be rotated with respect to the fixing base 13. The cutter 15 can be installed on the shaft 12, and can be driven by the shaft 12 to rotate to cut the workpiece W1. Besides, the machine tool 10 can be realized by such as a milling machine or other cutter capable of processing a workpiece by way of rotation. Furthermore, the vibration absorber 100 is not limited to being installed on the machine tool. For example, the vibration absorber 100 can be installed on a mechanical device with a rotation element, such as a fluid machinery with rotation blades.

The vibration absorber 100 can be installed on the fixing base 13 of the rotation module 11. As indicated in FIG. 1, the vibration absorber 100 is installed on the fixing base 13 through an adaptor 150. The vibration absorber 100 and the fixing base 13 are fixed. That is, there is no relative movement between the vibration absorber 100 and the fixing base 13, such that the coefficient of damping or the coefficient of elasticity will not occur between the vibration absorber 100 and the fixing base 13. Although it is not illustrated in the diagram, the adaptor 150 can be detachably fixed on the fixing base 13 through a fixer such as a screw or a latch. The adaptor 150 provides a surface 150s, which matches the installation surface 110s of the vibration absorber 100 and enables the vibration absorber 100 to be firmly connected onto the adaptor 150. If the installation surface 110s of the vibration absorber 100 is a flat bottom, the surface 150s of the adaptor 150 is a matching plane which enables the connector 110 of the vibration absorber 100 to be firmly installed on the adaptor 150. In an embodiment, the adaptor 150 can be a part of the vibration absorber 100 or a part of the machine tool 10. The vibration absorber 100 can reduce the response (such as amplitude or intensity) corresponding to the resonance frequency of the machine tool 10, such that the machine tool 10 will not chatter when operating at the resonance frequency.

As indicated in FIG. 1, the vibration absorber 100 is close to the shaft 12 of the rotation module 11 as much as possible to increase the effect of vibration reduction.

As indicated in FIG. 2, the horizontal axis denotes an operating frequency f of the machine tool 10, and the vertical axis denotes a response R (displacement/force) corresponding to the operating frequency f. As indicated in the diagram, the machine tool 10 has a specific resonance frequency fr. Since the vibration absorber 100 can reduce the response corresponding to the resonance frequency fr of the machine tool 10, the machine tool 10 equipped with the vibration absorber 100 will not resonate when operating at the resonance frequency fr, and therefore will not chatter. For example, since the response Ra corresponding to the resonance frequency fr of the machine tool 10 greatly reduces to the response Ra′ if the machine tool 10 is equipped with the vibration absorber 100, the machine tool 10 will not chatter. Due to the design of the vibration absorber 100, there is no need to deliberately avoid the operating frequency f of the machine tool 10 equipped with the vibration absorber 100 falling within the segment of the resonance frequency fr.

As indicated in FIG. 3, the horizontal axis denotes a rotation speed T of the machine tool 10, and the vertical axis denotes a cut depth t corresponding to the rotation speed T. The dashed area below the curve C denotes a processing stable area, and the area above the dashed area denotes an unstable area. During the operation of the machine tool 10, if the operating point corresponding to the cut depth t and the rotation speed T falls within the stable area, this implies that the machine tool 10 will not chatter. Conversely, if the operating point corresponding to the cut depth t and the rotation speed T falls within the unstable area, this implies that the machine tool 10 may chatter. Due to the design of the vibration absorber 100, even when the operating point corresponding to the cut depth t and the rotation speed T falls within the unstable area, the machine tool 10 still can avoid chattering. Thus, during the operation, the machine tool 10 is not be over-restricted by the rotation speed T and the cut depth t.

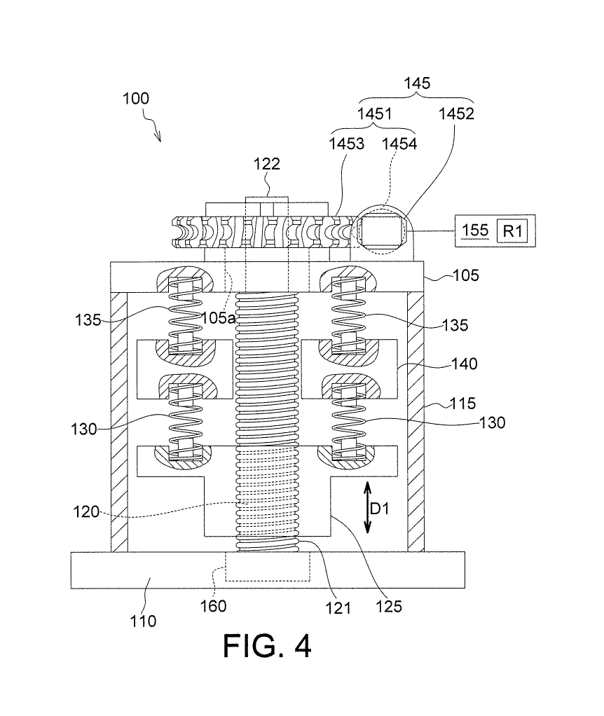

Referring to FIG. 4, a cross-sectional view of the vibration absorber 100 of FIG. 1 is shown. The vibration absorber 100 includes a cover 105, a connector 110, a casing 115, a screw 120, a displacement adjustment member 125, at least one first spring 130, at least one second spring 135, a mass block 140, a drive mechanism 145, an adaptor 150 (illustrated in FIG. 1) and a controller 155. The adaptor 150 can be selectively included in the vibration absorber 100. In another embodiment, the vibration absorber 100 may exclude the adaptor 150.

The cover 105 and the connector 110 are respectively cover two opposite openings of the casing 115. The connector 110 can be fixed on the fixing base 13 of the machine tool 10 either directly or indirectly through the adaptor 150 (illustrated in FIG. 1). The screw 120, the displacement adjustment member 125, the first spring 130, the second spring 135 and the mass block 140 can be disposed inside the casing 115 and protected by the casing 115. In other words, the casing 115 is configured to enclose the screw 120, the displacement adjustment member 125, the first spring 130, the second spring 135 and the mass block 140.

The screw 120 includes two ends 121 and 122. The lower end 121 can be rotatably supported on and connected to the connector 110 by one end. For example, the end 121 can be installed on a bearing 160 through which the end 121 is connected to the connector 110. The displacement adjustment member 125 is engaged with the screw 120. For example, the displacement adjustment member 125 is engaged with the screw 120, and when the screw 120 rotates, the displacement adjustment member 125, being restricted by the casing 115, can only move along an adjustment direction Dl. The mass block 140 is located between the first spring 130 and the second spring 135 and connects the first spring 130 and the second spring 135 on both sides, respectively. The screw 120 passes through the mass block 140. When the screw 120 is rotated, the mass block 140 is merely displaced but is not rotated. The first spring 130 is located between the mass block 140 and the displacement adjustment member 125 and connects respectively the mass block 140 and the displacement adjustment member 125 on both sides. The second spring 135 is located between the mass block 140 and the cover 105 and connects respectively the mass block 140 and the cover 105 by both ends. Thus, when the screw 120 is rotated and drives the displacement adjustment member 125 to move along the adjustment direction D1, the amounts of deformation of the first spring 130 and the second spring 135 can be changed.

In an embodiment, the coefficients of elasticity of both the first spring 130 and the second spring 135 are non-linear. Thus, when the amounts of deformation of both the first spring 130 and the second spring 135 change, this implies that the coefficients of elasticity of both the first spring 130 and the second spring 135 also change. By changing the coefficients of elasticity of both the first spring 130 and the second spring 135, the resonance frequency of the vibration absorber 100 can be adjusted. Thus, the coefficients of elasticity of both the first spring 130 and the second spring 135 can be adjusted, and the resonance frequency of the vibration absorber 100 can be adjusted to the resonance frequency fr of the machine tool 10 to avoid the machine tool 10 or the rotation module 11 chattering. However, the above exemplifications should be regarded in an illustrative rather than a restrictive sense.

Moreover, the embodiments of the present disclosure do not restrict the quantity of the first spring 130 or the quantity of the second spring 135. The quantity of the first spring 130 can be one, two, or more than two. When the quantity of the first spring 130 is one, the first spring 130 can be mounted on the screw 120 (surround the screw 120). When the quantity of the first spring 130 is two, the first spring 130 can be disposed symmetrically. Likewise, the quantity of the second spring 135 can be one, two or more than two, the disposition of the second spring 135 can be similar to that of the first spring 130, and the similarities are not repeated here. Furthermore, the quantity of the first spring 130 can be the same as or different from the quantity of the second spring 135.

As indicated in FIG. 4, the cover 105 has a through hole 105a. The upper end 122 of the screw 120 passes through the through hole 105a and protrudes from the cover 105, such that the drive mechanism 145 can connect the end 122 of the screw 120 at the outside of the casing 115. The drive mechanism 145 includes a transmission mechanism 1451 and a motor 1452. The motor 1452 can drive the transmission mechanism 1451 to rotate the screw 120 and move the displacement adjustment member 125 along the adjustment direction D1 to adjust the amount of deformation and the coefficient of elasticity of the spring. In an embodiment, the transmission mechanism 1451 can be realized by a reduction mechanism such as a worm gear set. To put it in greater detail, the transmission mechanism 1451 includes a worm wheel 1453 and a worm rod 1454, wherein the worm wheel 1453 being fixed on the end 122 of the screw 120 and the worm rod 1454 being engaged with the worm wheel 1453 reduce the movement of the screw 120.

The controller 155 is electrically connected to the motor 1452 for controlling the motor 1452 to drive the transmission mechanism 1451 to rotate the screw 120 and adjust the amount of deformation of the spring. The controller 155 can determine the amount of displacement corresponding to the operating frequency, at which the rotation module 11 or the machine tool 10 chatters, according to a relationship R1 of displacement and frequency. The relationship R1 of displacement and frequency can be pre-stored in the controller 155 or a storage unit (not illustrated). The relationship R1 of displacement and frequency is a correspondence relationship between the amount of displacement of the displacement adjustment member 125 and the resonance frequency of the vibration absorber 100. For example, the relationship R1 of displacement and frequency includes at least one set of correspondence relationships including a first amount of displacement and a first resonance frequency. When the displacement adjustment member 125 is displaced by the first amount of displacement along the adjustment direction D1, the resonance frequency of the vibration absorber 100 changes to the first resonance frequency to reduce the response corresponding to the first resonance frequency of the machine tool 10 equipped with the vibration absorber 100 and avoid the machine tool 10 equipped with the vibration absorber 100 chattering.

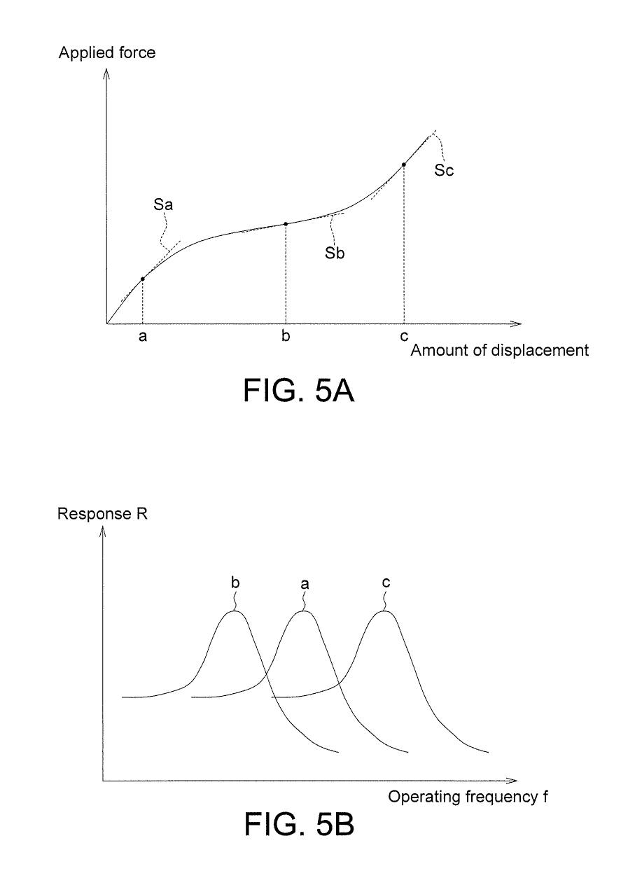

Refer to FIGS. 5A and 5B. FIG. 5A is a diagram of a relationship of amount of displacement and applied force of the displacement adjustment member 125 of FIG. 4. FIG. 5B is a diagram of relationship of operating frequency and response of the machine tool 10 of FIG. 4.

Refer to FIG. 5A. The points a, b and c respectively denote different amounts of displacement of the displacement adjustment member 125 generated when different forces are received by the spring. The slope at the curve of FIG. 5A denote a coefficient of elasticity of the spring. The points a, b and c have slopes Sa, Sb and Sc respectively. Since the slopes Sa, Sb and Sc are different from each other, it can be concluded that the coefficients of elasticity of the spring of the embodiments of the present disclosure are non-linear. Refer to FIG. 5B. Since the points a, b and c correspond to different resonance frequencies, it can be concluded that the resonance frequency of the machine tool 10 can be changed by changing the amount of displacement of the displacement adjustment member 125.

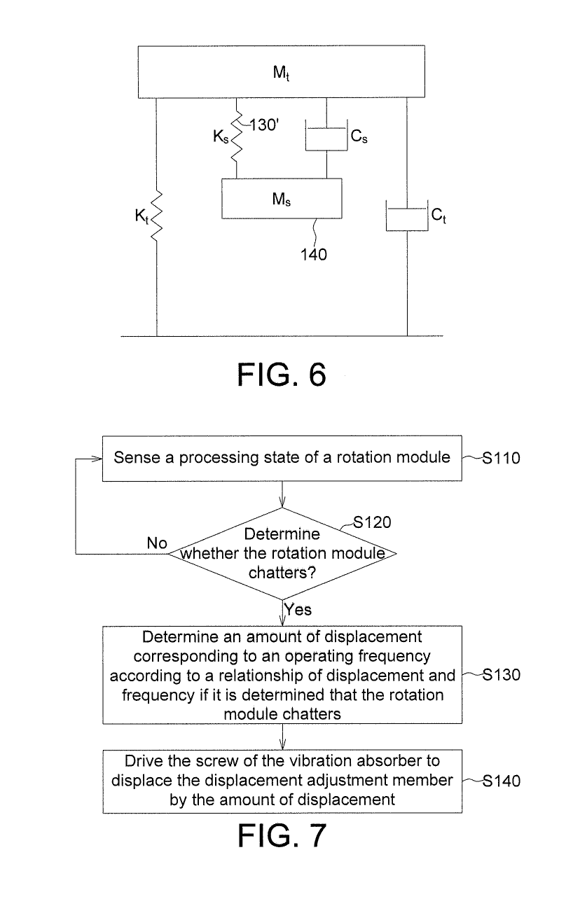

FIG. 6 is an equivalent system of the machine tool 10 of FIG. 1 equipped with a vibration absorber 100. The first spring 130 and the second spring 135 can form an equivalent spring 130′ having a coefficient of elasticity Ks. The mass block 140 has a mass Ms. The first spring 130 and the second spring 140 both have a damper, and the dampers of the first spring 130 and the second spring 140 can be equalized as a damper Cs. Moreover, the mass Mt, the coefficient of elasticity Kt and the damper Ct form an equivalent system of the machine tool 10. When the coefficient of elasticity Ks of the vibration absorber 100, the mass Ms and the damper Cs are added to the system, the overall resonance frequency of the system of FIG. 6 can be changed. For example, if the resonance frequency formed by the coefficient of elasticity Ks of the vibration absorber 100, the mass Ms and the damper Cs is substantially equivalent to the resonance frequency fr of the machine tool 10, then the response R corresponding to the resonance frequency fr of the machine tool 10 can be reduced after the vibration absorber 100 is installed in the machine tool 10 as indicated in FIG. 2.

FIG. 7 is a flowchart of a vibration reduction method according to an embodiment of the present disclosure. In step S110, the processing state of the rotation module 11 or the machine tool 10 is sensed by the sensor 14 (illustrated in FIG. 1), wherein the rotation module 11 is equipped with the vibration absorber 100 as indicated in FIG. 1. The sensor 14 is disposed on the fixing base 13 of the rotation module 11 and close to the shaft 12 to increase the accuracy of chatter sensing. For example, the sensor 14 can be disposed on the lower surface 13b of the fixing base 13 and close to the shaft 12. Besides, the sensor 14 is electrically connected to the controller 155 for transmitting a sensing signal to the controller 155. The sensor 14 can be realized by a microphone capable of sensing an audio frequency generated when the rotation module 11 rotates and further providing the audio frequency for the controller 155 to determine whether the machine tool 10 chatters.

In step S120, whether the rotation module 11 or the machine tool 10 chatters is determined by the controller 155. If so, the method proceeds to step S130; otherwise, the method returns to step S110.

In step S130, amount of displacement corresponding to an operating frequency (or resonance frequency) at which the machine tool chatters is determined according to a relationship R1 of displacement and frequency. The relationship R1 of displacement and frequency can be pre-stored in the controller 155 or a storage unit (not illustrated). The relationship R1 of displacement and frequency is a correspondence relationship between the amount of displacement of the displacement adjustment member 125 and the resonance frequency of the vibration absorber 100.

In step S140, the motor 1452 is controlled by the controller 155 to drive the screw 120 of the vibration absorber 100 to rotate and accordingly displace the displacement adjustment member 125 by the amount of displacement for adjusting the resonance frequency of the vibration absorber 100 to the operating frequency at which the machine tool chatters. Thus, the response of the machine tool 10 equipped with the vibration absorber 100 operating at the operating frequency will reduce, and therefore avoid the machine tool 10 chattering.

As disclosed above, the vibration absorber of the embodiments of the present disclosure can be disposed on a machinery, and the resonance frequency of the vibration absorber can be semi-actively adjusted to reduce the response (such as amplitude or intensity) of the machinery operating at the resonance frequency to avoid a large response damaging the machinery or affecting the operating quality of the machinery.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A vibration absorber for being installed on a rotation module, the vibration absorber comprises:
a screw;
a displacement adjustment member engaged with the screw;
a first spring;
a second spring;
a mass block located between the first spring and the second spring, wherein the mass block respectively connects the first spring and the second spring on both sides, and the screw passes through the mass block;
a casing configured to enclose the screw, the displacement adjustment member, the first spring, the second spring and the mass block;
a cover configured to cover one opening of the casing; and
a connector configured to cover the other opening of the casing;
wherein the first spring is located between the mass block and the displacement adjustment member and connects respectively the mass block and the displacement adjustment member by both ends, the second spring is located between the mass block and the cover and connects respectively the mass block and the cover by both ends, and the coefficients of elasticity of both the first spring and the second spring are both non-linear.

2. The vibration absorber according to claim 1, further comprising:
an adaptor configured to fix on the rotation module.

3. The vibration absorber according to claim 1, wherein the screw is rotatably supported on the connector by one end; the cover has a through hole for the other end of the screw to pass through and protrude from the cover.

4. The vibration absorber according to claim 3, further comprising:
a drive mechanism configured to connect the other end of the screw.

5. The vibration absorber according to claim 4, wherein the drive mechanism comprises:
a transmission mechanism engaged with the screw; and
a motor for driving the transmission mechanism to rotate the screw.

6. The vibration absorber according to claim 4, further comprising:
a controller configured to determine an amount of displacement corresponding to an operating frequency at which the rotation module chatters, according to a relationship of displacement and frequency, as to control the drive mechanism to rotate the screw to displace the displacement adjustment member by the amount of displacement.

7. The vibration absorber according to claim 6, wherein the relationship of displacement and frequency is a correspondence relationship between the amount of displacement of the displacement adjustment member and a resonance frequency of the vibration absorber.

8. A semi-active vibration reduction method, comprising the steps of:
sensing a processing state of a rotation module equipped with the vibration absorber as claimed in claim 1;
determining whether the rotation module chatters;
determining an amount of displacement corresponding to an operating frequency according to a relationship of displacement and frequency if it is determined that the rotation module chatters; and
driving the screw of the vibration absorber to displace the displacement adjustment member by the amount of displacement.

9. The semi-active vibration reduction method according to claim 8, wherein the relationship of displacement and frequency is a correspondence relationship between the amount of displacement of the displacement adjustment member and a resonance frequency of the vibration absorber.
